(19) United States
(12) Patent Application Publication
(10) Pub. No.: US 2024/0169411 A1
(43) Pub. Date: May 23, 2024

(54) SYSTEMS AND METHODS FOR DYNAMICALLY GENERATING MODIFIED USER INTERFACES FOR SIMILAR PRODUCT RECOMMENDATIONS

(71) Applicant: COUPANG CORP., Seoul (KR)

(72) Inventors: Nishant AGRAWAL, Seoul (KR); Chetan RAO, Seoul (KR); Ashutosh PENDSE, Seoul (KR); Yiwei SUN, Seoul (KR); Taeoh KIM, Seoul (KR); Dongcheng WANG, Seoul (KR)

(21) Appl. No.: 17/990,054

(22) Filed: Nov. 18, 2022

(51) Int. Cl. G06Q 30/06

(52) U.S. Cl. CPC G06Q 30/0631; G06Q 30/0623; G06Q 30/0643

(57) ABSTRACT

A computerized system and method for dynamically generating modified user interface is disclosed. The method comprises receiving a search request, providing a list of at least one product in response to the search request, receiving a selection of a first product from the user device, providing the first product to the user device for display on the user interface, determining signals of the first product and their weights, calculating a score for each of the second products based on signals of the first product, ranking the second products by the score, and in response to receiving a request to redisplay the list of product, providing, to the user device for display together with the list of product, at least one second product based on the ranking.

### TECHNICAL FIELD

The present disclosure generally relates to computerized systems and methods for dynamically generating modified user interfaces for presenting similar product recommendations for easy selection by a user. In particular, embodiments of the present disclosure relate to inventive and unconventional systems for finding and determining similar products to a given product, and displaying the similar products on a dynamic user interface that is convenient for users to review.

### BACKGROUND

Present day online shopping websites may make a large variety of products available for customers to choose from. A group of similar products may come from different manufacturers, may have different configurations in one of many aspects, may have different prices (including product selling prices and shipping costs), or may have different warranty terms, for example. Consumers may conduct searches to locate products. However, in many instances, consumers do not have a specific product in mind and are open to suggestions from those websites. Similar products may be displayed to increase the likelihood of generate sales and improve consumer experience.

The website's suggestions may be added for display on a product page. The suggested products may share some similarities with the product being viewed. However, this suggestion is mostly static, only considering the similarities of product characteristics. By implementing an improved algorithm to identify and rank the suggestions, it is more likely to capture the consumer's intention, or generate interests from the consumer, and thus improve sales.

Moreover, displaying the suggestions on a product page may interrupt the consumer's search process. Clicking on a suggested product will deviate from the ongoing search. Consumer may prefer complete comparing products that showed up on his/her own searches. This causes difficulty, especially with mobile user interface flows, because of the limited space on the screen and limited options for navigation and information display. A more user-friendly user interface that includes suggested products can improve the user experience and provide an improved user interface for use on limited devices. This technological improvement can, in turn, generate more sales by making it more convenient to select products that may more likely interest the consumer.

Therefore, there is a need for improved methods and systems for finding and displaying similar products in a more efficient and user-friendly way to generate more sales and improve user experience.

### SUMMARY

One aspect of the present disclosure is directed to a computerized system for dynamically generating modified mobile user interfaces, the system comprising at least one storage devices comprising instructions, at least one processors configured to execute the instructions to perform the steps of: receiving a search request from a user device, providing, to a user interface on the user device, a list of at least one products in response to the search request, receiving a selection of a first product from the list of at least one products from the user device, providing the first product to the user device for display on the user interface, determining at least one signals of the first product and a weight for each of the at least one signals of the first product, wherein the at least one signals comprise product attribute category signals and social interaction category signals, determining at least one second products, calculating a score for each of the at least one second products based on the at least one signals of the first product, ranking the at least one second products by the score, and, in response to receiving a request to redisplay the list of at least one products, providing, to the user device for display together with the list of at least one products, at least one second products.

Another aspect of the present disclosure is directed to a method for for dynamically generating modified mobile user interfaces, comprising receiving a search request from a user device, providing, to a user interface on the user device, a list of at least one products in response to the search request, receiving a selection of a first product from the list of at least one products from the user device, providing the first product to the user device for display on the user interface, determining at least one signals of the first product and a weight for each of the at least one signals of the first product, wherein the at least one signals comprises product attribute category signals and social interaction category signals, determining at least one second products, calculating a score for each of the at least one second products based on the at least one signals of the first product, ranking the at least one second products by the score, and, in response to receiving a request to redisplay the list of at least one products, providing, to the user device for display together with the list of at least one products, at least one second products.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary process to respond to a user search and a subsequent selection of product for view, consistent with the disclosed embodiments.

FIG. 4 is a diagrammatic illustration of an exemplary process to respond to a user request to return to a previous search result, consistent with the disclosed embodiments.

FIG. 5 is a diagrammatic illustration of an exemplary composition of product signals, consistent with the disclosed embodiments.

FIG. 6 depicts a sample updated Search Result Page (SRP), consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for finding similar products, in particular, for finding and determining similar products to a given product, and displaying the similar products on a user interface that is convenient for users to review.

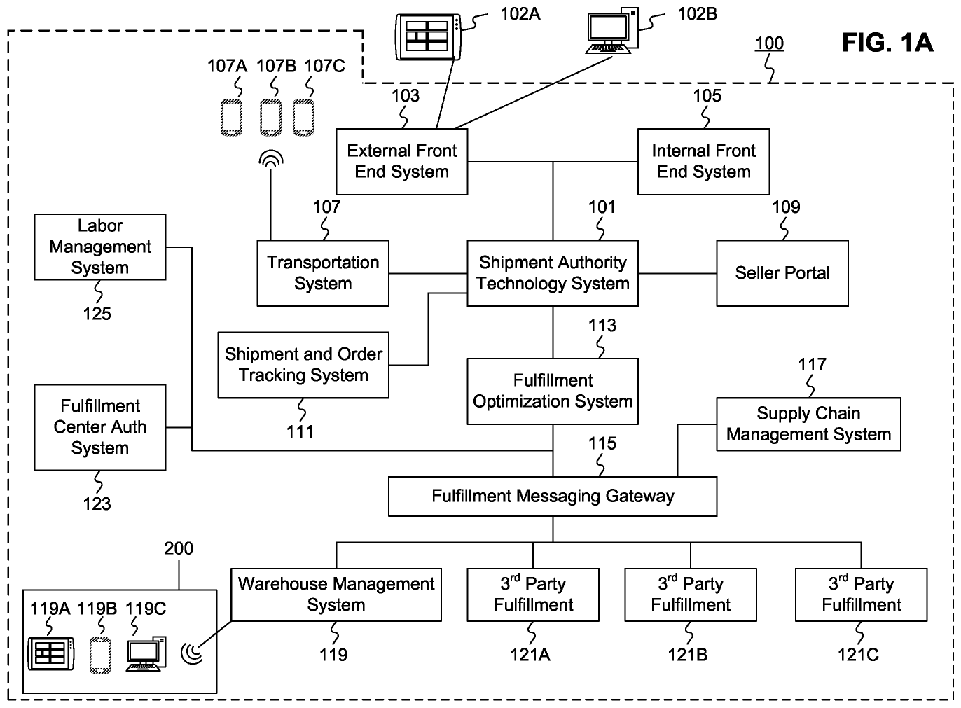

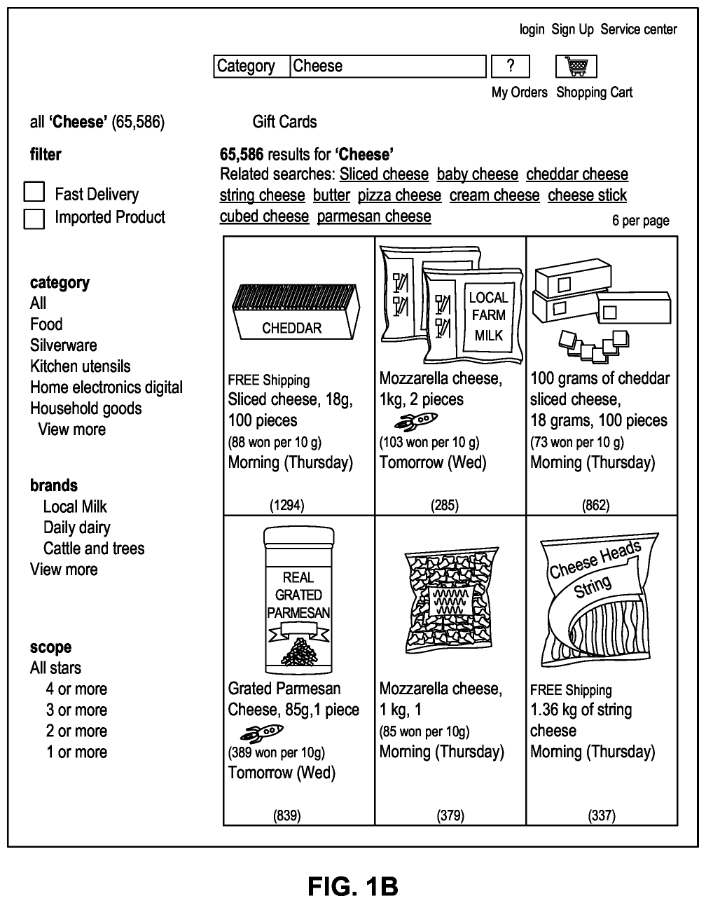

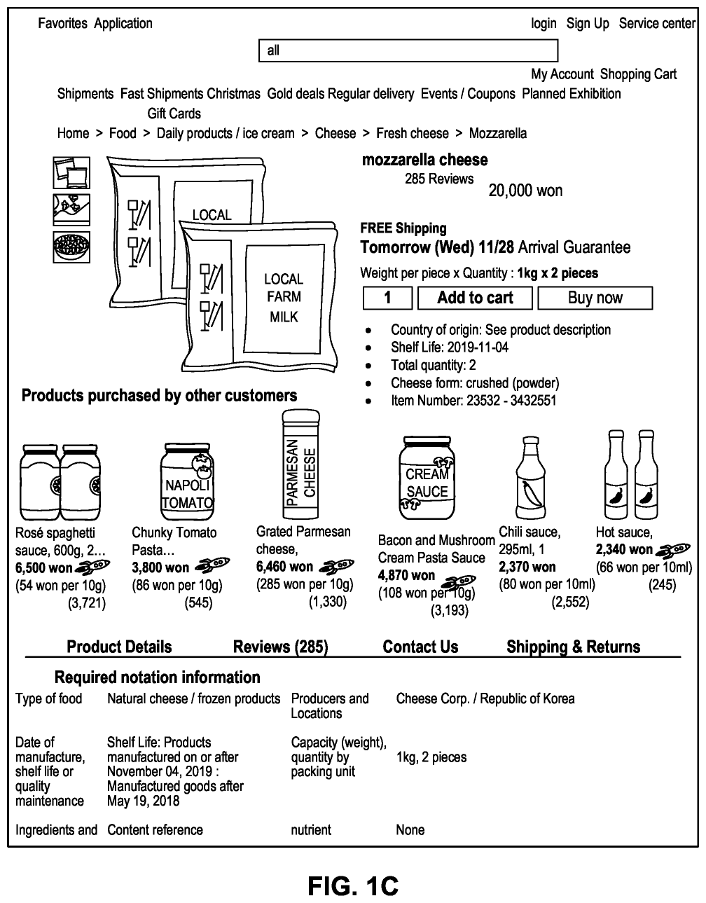

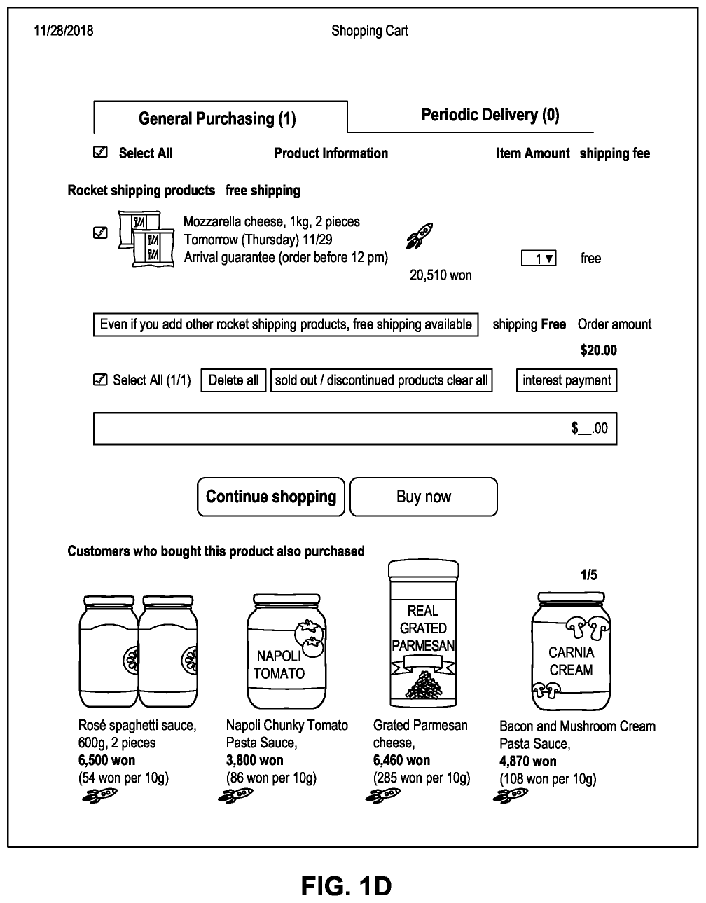

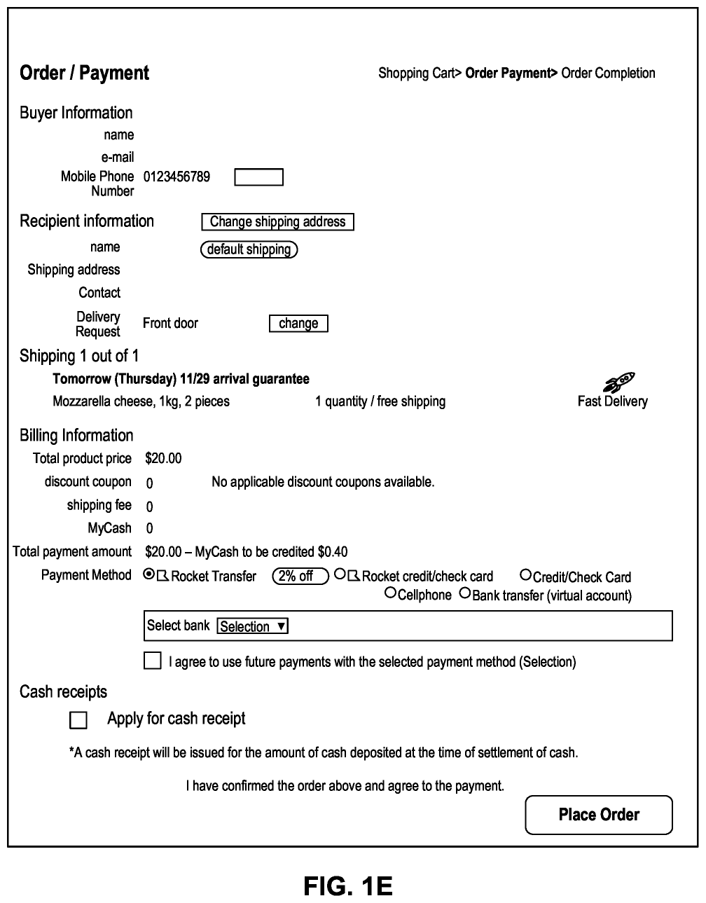

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 1026) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

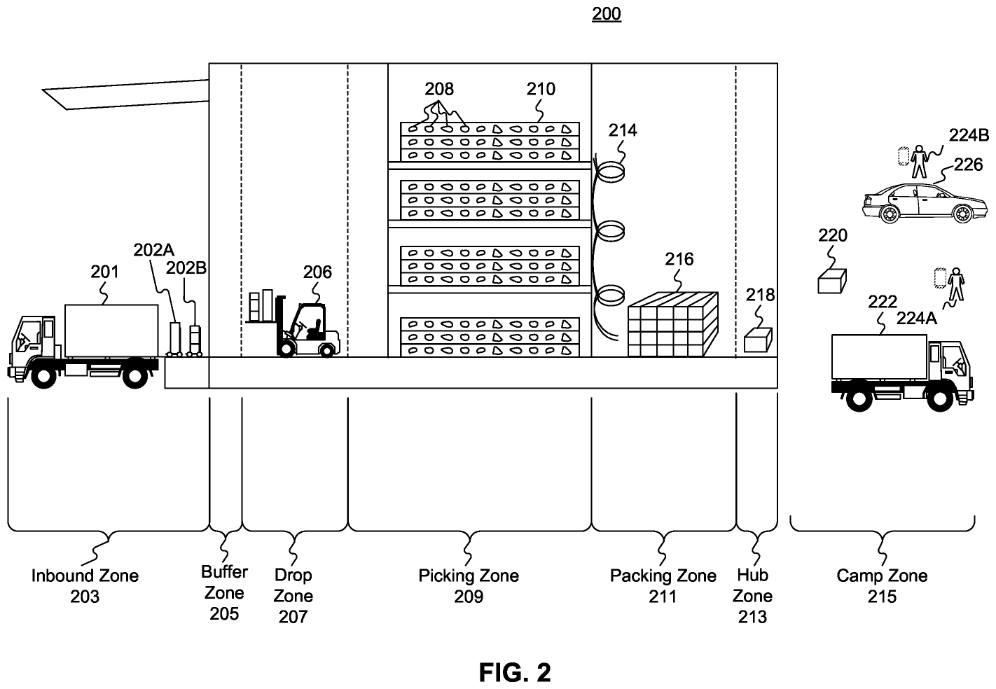

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 2246.

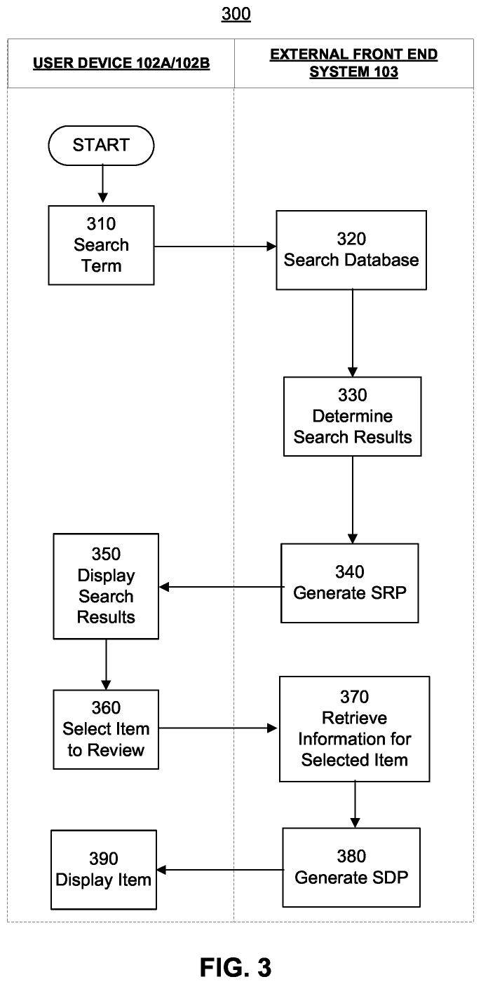

FIG. 3 is a diagrammatic illustration of an exemplary process 300 to respond to a user search and a subsequent selection of product for view, consistent with the disclosed embodiments.

In some embodiments, in step 310, a user may provide a search term on a user device (e.g., mobile device 102A or computer 102B) through a user interface. In some embodiments, the user device (e.g., using mobile device 102A or computer 102B) may navigate to external front end system 103 and request a search by entering information into a search box. The user may provide the search term via keyboard input, or by clicking/selecting using a pointer device (e.g., touch screen selection, stylus, mouse, etc.) The external front end system 103 (e.g., a web server) may receive the search requests (e.g., via a network), perform searches, and prepare SRP, as disclosed prior. In some embodiments, the generated SRP may be stored in a database of the external front end system 103, and may further be transferred to other subsystems of system 100. In some embodiments, the generated SRP may be stored in a cache (e.g., on the external front end system 103, or the user device) to allow faster re-activate and re-display.

In steps 320, the external front end system 103 may receive the search term from the user device and perform the search in a product database. External front end system 103 may request information from one or more systems in system 100. External front end system 103 may then prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network). The product database may be part of the external front end system 103, the internal front end system 105, or other subsystems of system 100.

In step 330, the search result may be obtained or received by the external front end system 103. In some embodiments, the external front end system 103 may determine how the search result should be presented, e.g., the order of display of the products in the search result. In some embodiments, the external front end system 103 may analyze the search result and determine relevance of each product in the search result to the user intention. In some embodiments, the external front end system 103 may determine the relevance based on prior search histories, e.g., a product that was previously searched may indicate a higher relevance to the present search. Additionally or alternatively, the external front end system 103 may determine the relevance based on preset criterion for products of certain categories, because some characteristics may exist for different products, but the relevance may be vastly different. For example, screen size and CPU speed may be considered more relevant in a search for laptops than color, while color may be considered more relevant in a search for dress than size.

In step 340, external front end system 103 may prepare (e.g., generate or re-generate) a Search Result Page (SRP) based on the search results and the determination of relevance, for example, as discussed above with respect to FIG. 1B. The SRP may include information that satisfies the search request in step 310. For example, this may include pictures and/or links of products that satisfy the search request. External front end system 103 may send the SRP to the requesting user device (e.g., via a network).

In step 350, requesting user device may display the SRP in a user interface (e.g., FIG. 1B).

A user then may, as in step 360, through the user device, select a product from the SRP, e.g., by clicking or tapping a user interface, or using another input device, to select a product represented on the SRP. The user device may formulate a request (e.g., by a link) for information on the selected product and send it to external front end system 103.

In step 370, in response to the selection in step 360, external front end system 103 may request or retrieve information related to the selected product. For example, the information may include additional information beyond that presented for a product on the respective SRP. This could include, for example, shelf life, country of origin, weight, size, number of items in package, handling instructions, or other information about the product.

In some embodiments, the external front end system 103 may use the product information for recommendations of similar products. In some embodiments, the product information may include, for example, product price, product category, product characteristics, etc. In some embodiments, one product may belong to multiple related or unrelated categories. For example, paper towel may belong to both kitchen products and paper products. In some embodiments, product information may include any detail information of the product. For example, a dress may have information about color, material, size, style, brand, special features (e.g., laces), washing instructions, etc.

In step 380, external front end system 103 may prepare an SDP (Single Detail Page) based on the received product information, for example, as discussed above with respect to FIG. 1C. External front end system 103 may deliver the SDP to the requesting user device (e.g., via a network).

In step 390, the requesting user device may receive, then display the SDP which lists the product information. Upon receiving the SDP, the user then may, through the user device, interact with the SDP, as discussed in previous sections. For example, a user of the requesting user device may click or otherwise interact with a “Place in Cart” button on the SDP. This adds the product to a shopping cart associated with the user. The user device may transmit this request to add the product to the shopping cart to external front end system 103. The user may click or otherwise interact with a “Back” button on the SDP. The user device may transmit this request to go back to SRP on the user interface. The external front end system 103 may process the request to return to a previous search result.

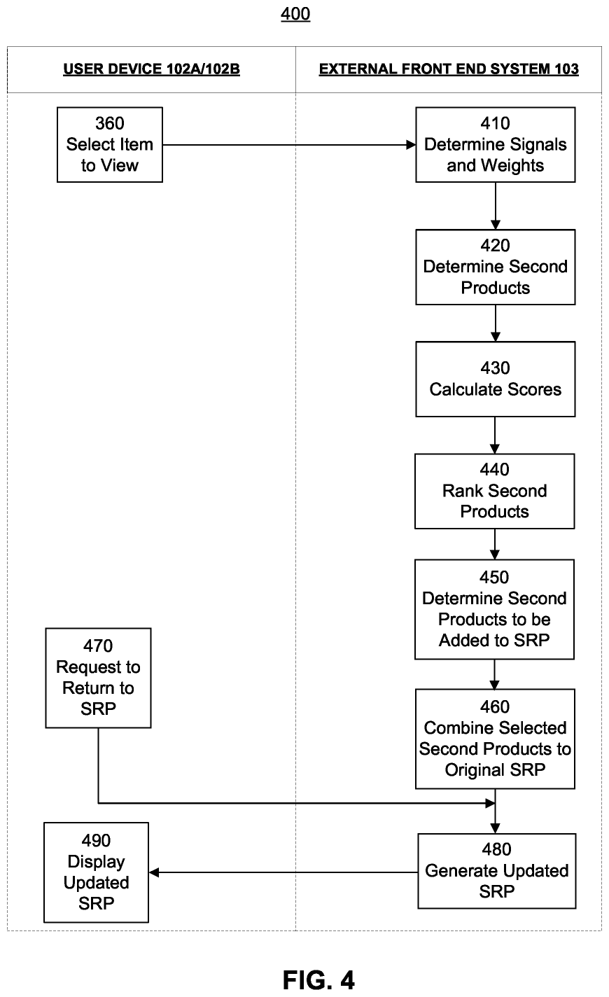

FIG. 4 is a diagrammatic illustration of an exemplary process 400 to respond to a user request to return to a previous search result, consistent with the disclosed embodiments. In some embodiments, this exemplary process may also be a respond to a user request to conduct a repeated search.

In some embodiments, the external front end system 103 may begin to determine similar products after the user requests to go back to the SRP. However, in some embodiments, upon selection of a product in step 360, while displaying the SDP on the user interface, the external front end system 103 may begin to determine similar products. Advantageously, in these embodiments, external front end system 103 may prepare an updated SRP with suggestions of similar products because the user specifically requests the SRP again.

In step 410, the external front end system 103 may, based on the product selected, determine at least one signal of the first product and a weight for each of the signals for the selected product. The signals are, in some embodiments, preset indicators for the external front end system 103 to search for and determine similar products. In some embodiments, the signals may be assigned by sellers or authorized personnel, or generated by the external front end system 103.

In some embodiments, the signals are product specific. Each signal is assigned a weight. The weight of the signal indicates the signal's importance in the process of searching and determining similar products. In some embodiments, the at least one signal and the weight for each of the signals are stored in a database in the external front end system 103.

In some embodiments, different products may have different signals with different weights. The weight assignments may come from a preset criteria, or may be adjusted by internal front end system 105. In some embodiments, weights may be iteratively adjusted automatically, based on a machine learning algorithm. In other words, current user behavior may in turn impact future calculations by taking into account the current user behavior into weight determinations in the future. For example, if a user adds a search term for screen sizes after an initial search term “laptop,” the weight of the screen size as a signal may increase. The external front end system 103 may assign the increased weight of the signal “screen size” in response to future searches of “laptop.” This weight adjustment may be applied to this specific user, or any other users who may conduct the similar search.

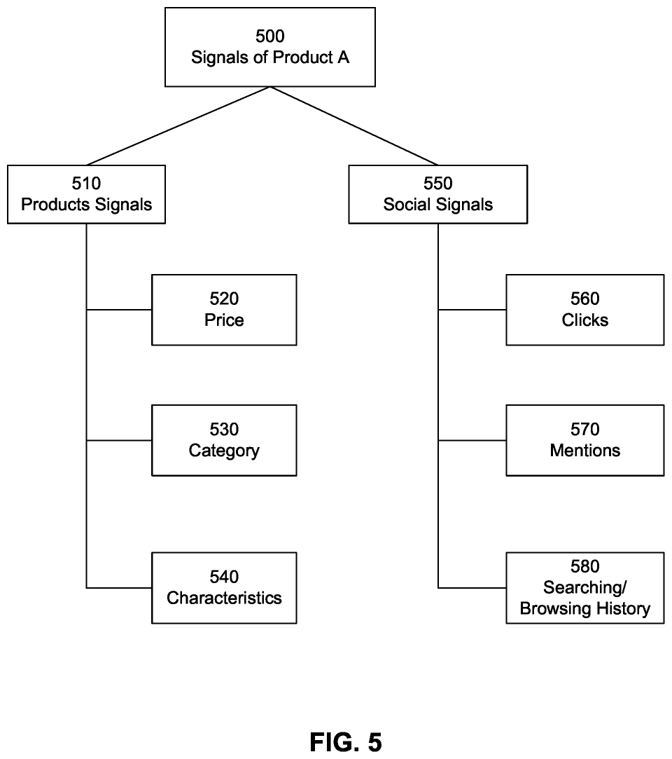

In some embodiments, the signals may be of two categories. As shown in FIG. 5, signals 500 may be product characteristic related signals 510, or social interaction related signals 550.

In some embodiments, product characteristic related signals 510 may be similar to the product information discussed in previous sections, including price 520, product categories 530, or any other product characteristics 540, etc. In some embodiments, one product may belong to multiple related or unrelated categories. For example, paper towel may belong to both kitchen products and paper products. In some embodiments, product information may include any detail information of the product. For example, a dress may have information about color, material, size, style, brand, special features (e.g., laces), washing instructions, etc.

In some embodiments, product price 520 as a signal may be normalized for weight assignment purposes. A price distribution of products in a same category may be applied to determine similarity in pricing compared to a target price (e.g., the listed price of the target product). For example, a product A priced about one standard deviation away from the price of A's target product B would score the same with a product C priced about one standard deviation away from the price of C's target product D, regardless of the absolute value of the prices.

In some embodiments, product may belong to different categories of different weights. In general, smaller categories may indicate higher similarity and therefore may have higher weights. In some embodiments, if category A is a subset of category B, either category A or category B may be considered, but not both.

In some embodiments, each of the product characteristics 540 as a signal may be assigned a weight, similar to the relevance of product information discussed above. In some embodiments, not all characteristics are considered. For example. a dress may be characterized as both cotton and 100% cotton. Depending on the search term and search history, either the more specific term or the less specific term may be dropped from consideration. For example, a search term specifying “single malt” may cause the system to drop a characteristic of “whisky” because “single malt” is more specific than “whisky” and all “single malt” are “whisky;”, while the external front end system 103 may determine, based on the search history (e.g., the user may have searched whiskies from Scotland, Japan, and the United States in a same session, which the system may determine that the user does not have a strong preference on the origin of the whisky as a characteristic), that a more specific term (e.g., scotch) does not reflect the true intention of the user, thus dropping the more specific term (e.g., scotch) from consideration.

In some embodiments, some signals 500 (e.g., characteristics 540) may be dropped by being assigned a zero weight. In some embodiments, dropping a characteristic may mean that the external front end system 103 assigning a zero importance/weight to the characteristic, effectively removing the characteristic from subsequent calculation, or ignoring products selected by considering the characteristic.

In some embodiments, the social signals 550 may include historic data. For example, number of instances when two products were viewed during a same session, or “connections” between the two products, e.g., “clicks” 560. In some embodiments, the direction of this product connection, e.g., which product was viewed first during a session, may or may not have significances. In some embodiments, the connections may include data correlating views from all users.

In some embodiments, the social signals 550 may include historic data of the number of instances two products were referenced in a same comment, e.g., a direct comparison, with or without preference, as in “mentions” 570. This may be an indicator of some similarity of the two products.

In some embodiments, the social interaction signals 550 may be customized for users, especially when a specific user has identified himself/herself through means of cookie or log-in. In some embodiments, browsing history and/or searching history of a user 580 may be used to identify additional social interaction signals. For example, products searched within a certain number of days may indicate a decent level of interest from the user and thus be considered a social interaction signal 550. In some embodiments, the external front end system 103 may consider the time lapsed between the historic search/view and the present session to gauge interest level, thus assigning weights accordingly. Generally, the more frequently user views/searches for a specific item, the higher his/her interest level is. For example, the view history where a user browsed product A for less than five seconds, but browsed product B for over five minutes may indicate that the user has a higher interest level in product B over product A; a user repeatedly searching and viewing product C may indicate a higher interest level in it over product D, where a single search and view of it was conducted a week ago. In some embodiments, the view/search history 580 may include those conducted on third party websites/apps.

Moving back to FIG. 4, in step 420, the external front end system 103 may preliminarily determine at least one similar products for recommendation. In some embodiments, this determination may have a lower relevance standard to capture a wide range of items. For example, a product may be preliminarily selected if it contains one or more signals of the product being shown on SDP. In some embodiments, this determination may focus on certain aspects of the signals decided in step 410. For example, only certain signals above a certain threshold weight are used to preliminarily identify similar products, or a product is only chosen when at least a certain number of signals are detected.

In step 430, a score may be calculated for each of the preliminarily selected similar products, based on the signals and weights determined in step 410. In some embodiments, the score is normalized to allow direct comparison. For example, the score may be normalized to from 0 to 1, or from 0 to 100.

In step 440, the external front end system 103 may rank the preliminarily selected similar products by their scores. A higher score may indicate a likelihood of a higher interest level from the user. In some embodiments, additional signals may be added to the calculation as a tie breaker as needed. In other embodiments, external front end system 103 may break ties with random selection, round robin selection, alphabetical selection, or other methods.

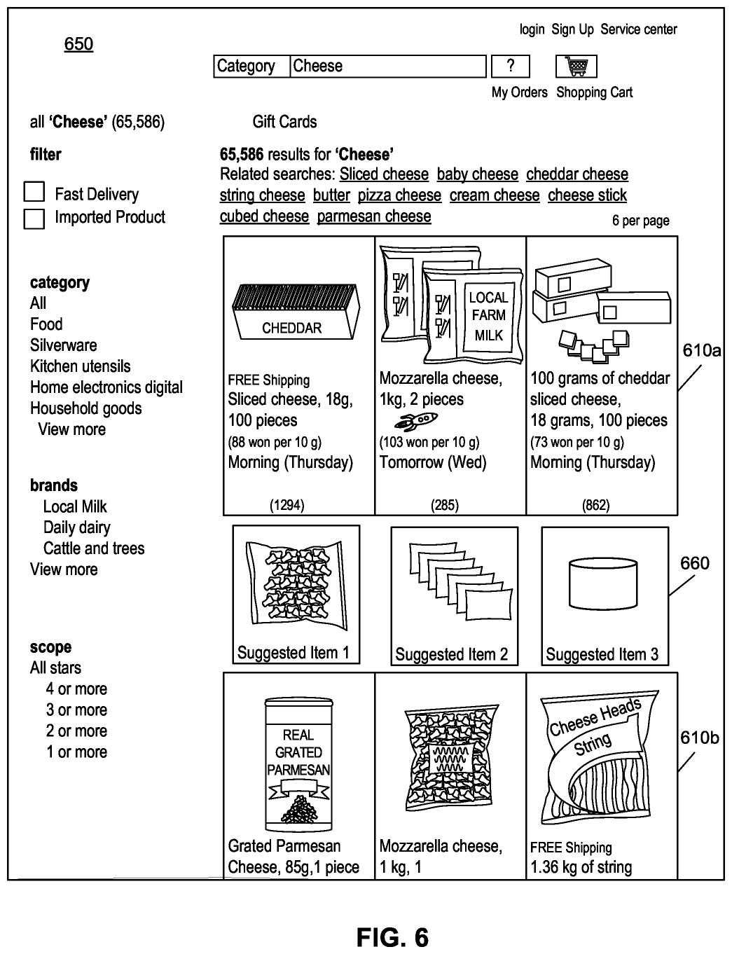

In step 450, the external front end system 103 may determine to shortlist at least one top ranked product from step 440. The external front end system 103 may determine the number of the shortlisted products by the user interface capacity. In some embodiments, the external front end system 103 may shortlist more products than can be displayed at one time. The excessive shortlisted products may serve to accommodate changes on the user interface end, or serve as replacements. For example, when the user device is a smartphone, and the user changed the orientation of the smartphone from portrait to landscape, more products may be accommodated in a row. Some excessive shortlisted products may thus be accommodated on the screen. Additional details are discussed in later sections (e.g., discussion on FIG. 6) with respect to accommodating the shortlisted products in the updated SRP in the user interface.

In some embodiments, the external front end system may drop some products from the shortlisted products when they are already added to the shopping cart, or when the user has purchased them.

In step 460, the external front end system 103 may then combine the shortlisted products with the list of products in the original SRP (e.g., SRP stored in a cache.) Together, the external front end system 103 may provide the products to the user device in response to the user request of returning to SRP in step 470.

In step 480, in response to the user request of returning to SRP in step 470, the external front end system 103 may generate an updated SRP to combine the original SRP (e.g., SRP stored in cache) together with the shortlisted products. The external front end system 103 may then send the updated SRP to the requesting user device for displaying. In some embodiments, the original SRP may be stored in a cache on the user device. The external front end system 103 may send the shortlisted products to the user device and instruct the user device to combine and display the shortlisted products with the original SRP stored in cache.

In some embodiments, in response to a user request of conducting a repeated search after viewing a product, when there is no stored SRP in the cache, the external front end system 103 may first conduct a search and generate an SRP, then proceed to combine the SRP with the shortlisted products.

In step 490, the requesting user device may display the updated SRP in a user interface. In some embodiments, the updated SRP includes the original SRP, making the user's original searching process uninterrupted, thus improving the user experience.

As shown in FIG. 6, the updated SRP 650 may include the original SRP 610a and 610b and suggested similar products 660 that are shortlisted in step 450. In some embodiments, the external front end system 103 may provide the suggested similar products to the user device (e.g., mobile device 102A or computer 102B) with instructions regarding displaying locations. In this exemplary embodiment, the external front end system 103 instructed the user device to split the list of products in the original SRP 610 (including, e.g., 610a, 610b) into two portions 610a and 610b, and to insert the suggested similar products 660 in between the two portions.

In some embodiments, the external front end system 103 may merge the suggested similar products with the list of products from the original SRP 610a, 610b and generate an updated list of products. The external front end system 103 may then provide the updated list of products to the user device (e.g., mobile device 102A or computer 1026) for display.

In some embodiments, the external front end system 103 may instruct the user device (e.g., mobile device 102A or computer 102B) to display a portion of the list of products in the original SRP 610a, display the suggested similar products 660, then continue to display a second portion of the list of products in the original SRP 610b. In some embodiments, the suggested similar products are displayed as a banner inserted between the original SRP 610a and 610b (e.g., under the first row of products in the original SRP 610a). In some embodiments, the banner may be at a different location, e.g., at the bottom of the user interface, etc.

Advantageously, the user may be able to resume his/her search process with minimum interruption, while seeing the suggested similar products. This may improve the user experience using the search function.

In some embodiments, when a user switches between at least one SDP and SRP (e.g., browses multiple products from a search result,) steps 360-390 and 410-490 may be repeated. In some embodiments, step 450 may take into account previous selections and eliminate already displayed products.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for dynamically generating modified user interfaces, the system comprising:
at least one storage device comprising instructions;
at least one processor configured to execute the instructions to perform the steps of:
receiving a search request from a user device;
providing, to a user interface on the user device, a list of at least one products in response to the search request;
receiving a selection of a first product from the list of at least one products from the user device;
providing the first product to the user device for display on the user interface;
determining at least one signals of the first product and a weight for each of the at least one signals of the first product, wherein the at least one signals comprises product attribute category signals and social interaction category signals;
determining at least one second products;
calculating a score for each of the at least one second products based on the at least one signals of the first product;
ranking the at least one second products by the score; and
in response to receiving a request to redisplay the list of at least one products, providing, to the user device for display together with the list of at least one products, the at least one second products.

2. The system of claim 1, wherein the social interaction data are based on:
number of instances when a second product is clicked on before the first product was viewed during a session;
number of instances when a second product is clicked on after the first product was viewed during a session; or
number of instances when a second product and the first product were referenced in a single comment.

3. The system of claim 1, wherein determining the at least one second products comprises:
determining a second product having a same or similar product attribute; or
determining a second product having a high level of social interaction with the first product.

4. The system of claim 3, wherein the product attributes comprise:
a listing price;
at least one category to which the first product belongs to; and
at least one property of the first product.

5. The system of claim 4, wherein the at least one properties of the first product is received from a seller of the first product.

6. The system of claim 4, the steps further comprising extracting the at least one properties of the first product from a name of the first product.

7. The system of claim 3, wherein the high level of social interaction comprises:
prior searching history or prior browsing history of a user;
the second product and the first product were viewed during a same session; or
the second product and the first product were referenced in a same comment.

8. The system of claim 1, wherein the providing the at least one second products comprises providing instructions to cause the user device to:
split the list of at least one products into a first portion of the list of at least one products and a second portion of the list of the at least one products;
insert the at least one second products to the list of at least one products, between the first portion and the second portion.

9. The system of claim 1, the steps further comprising:
in response to receiving a request to redisplay the list of at least one products, updating the list of at least one products to include the at least one second products.

10. The system of claim 1, wherein:
the user device is a mobile device, and
providing the at least one second products to the user device comprises providing instructions to cause the user device to:
display a first portion of the list of at least one products in a first position;
display at least one of the at least one second products below the displayed first portion; and
display a second portion of the list of at least one products in a second position below the displayed at least one second products.

11. A method for dynamically generating modified user interfaces, comprising:
receiving a search request from a user device;
providing, to a user interface on the user device, a list of at least one products in response to the search request;
receiving a selection of a first product from the list of at least one products from the user device;
providing the first product to the user device for display on the user interface;
determining at least one signals of the first product and a weight for each of the at least one signals of the first product, wherein the at least one signals comprises product attribute category signals and social interaction category signals;
determining at least one second products;
calculating a score for each of the at least one second products based on the at least one signals of the first product;
ranking the at least one second products by the score; and
in response to receiving a request to redisplay the list of at least one products, providing, to the user device for display together with the list of at least one products, the at least one second products.

12. The method of claim 11, wherein the social interaction data are based on:
number of instances when a second product is clicked on before the first product was viewed during a session;
number of instances when a second product is clicked on after the first product was viewed during a session; or
number of instances when a second product and the first product were referenced in a single comment.

13. The method of claim 11, wherein determining the at least one second products comprises:
determining a second product having a same or similar product attribute; or
determining a second product having a high level of social interaction with the first product.

14. The method of claim 13, wherein the product attributes comprise:
a listing price;
at least one categories to which the first product belongs to; and
at least one properties of the first product.

15. The method of claim 14, wherein the at least one properties of the first product is received from a seller of the first product.

16. The method of claim 14, further comprising extracting the at least one properties of the first product from a name of the first product.

17. The method of claim 13, wherein the high level of social interaction comprises:
prior searching history or prior browsing history of a user;
the second product and the first product were viewed during a same session; or
the second product and the first product were referenced in a same comment.

18. The method of claim 11, wherein the providing the at least one second products comprises providing instructions to cause the user device to:
split the list of at least one products into a first portion of the list of at least one products and a second portion of the list of the at least one products;
insert the at least one second products to the list of at least one products, between the first portion and the second portion.

19. The method of claim 11, further comprising:
in response to receiving a request to redisplay the list of at least one products, updating the list of at least one products to include the at least one second products.

20. The method of claim 11, wherein:
the user device is a mobile device, and
providing the at least one second products to the user device comprises providing instructions to cause the user device to:
display a first portion of the list of at least one products in a first position;
display at least one of the at least one second products below the displayed first portion; and
display a second portion of the list of at least one products in a second position below the displayed at least one second products.
